(19) United States
(12) Patent Application Publication
(10) Pub. No.: US 2026/0368743 A1
(43) Pub. Date: Nov. 19, 2026

(54) UTILIZING A MACHINE LEARNING TO PREDICT DEPOSIT TRANSACTION ACTIVITIES

(71) Applicant: Chime Financial, Inc., San Francisco, CA (US)

(72) Inventors: Jigar Mehta, Milpitas, CA (US); Andrew Robert Ratcliffe, San Francisco, CA (US)

(21) Appl. No.: 19/208,237

(22) Filed: May 14, 2025

(51) Int. Cl. G06Q 20/42; G06Q 20/30

(52) U.S. Cl. CPC G06Q 20/42; G06Q 20/30

(57) ABSTRACT

The disclosure describes embodiments of systems, methods, and non-transitory computer readable storage media that utilize a machine learning classification model to generate deposit transaction activity predictions. Indeed, the disclosed system can utilize a digital activity stream to identify user accounts that have inactivated deposit transaction activities. In addition, in one or more implementations, the disclosed system utilizes a machine learning classification model to generate a predicted classification label to indicate whether a user account is likely to reactive deposit transaction activities. Moreover, the disclosed system can dynamically initiate one or more downstream electronic tasks for deposit transaction reactivation based on the predicted classification label indicating whether the user account will reactivate future deposit transaction activities.

### BRIEF DESCRIPTION OF THE DRAWINGS

The detailed description is described with reference to the accompanying drawings in which:

FIG. 1 illustrates a schematic diagram of an environment for implementing an inter-network facilitation system and a digital transaction activity detection system in accordance with one or more implementations.

FIG. 2 illustrates an overview of a digital transaction activity detection system utilizing deposit transaction activity predictions to dynamically initiate electronic tasks for deposit transaction reactivation in accordance with one or more implementations.

FIG. 3 illustrates a digital transaction activity detection system detecting electronic deposit transaction inactivity from user accounts in accordance with one or more implementations.

FIG. 4 illustrates a digital transaction activity detection system utilizing a machine learning classification model to generate deposit transaction activity predictions in accordance with one or more implementations.

FIG. 5 illustrates a flow diagram of the digital transaction activity detection system dynamically initiating electronic communications with a user account based on deposit transaction reactivation predictions in accordance with one or more implementations.

FIG. 6 illustrates a digital transaction activity detection system dynamically initiating one or more downstream electronic tasks based on a deposit transaction reactivation prediction in accordance with one or more implementations.

FIG. 7 illustrates an example of a digital transaction activity detection system transmitting an electronic communication to a user account based on future deposit transaction reactivation predictions in accordance with one or more implementations.

FIG. 8 illustrates a digital transaction activity detection system utilizing future deposit transaction reactivation predictions to model and determine target user features in accordance with one or more implementations.

FIGS. 9, 10, 11, and 12 illustrate experimental results for an implementation of a digital transaction activity detection system in accordance with one or more implementations.

FIG. 13 illustrates a flowchart of a series of acts for utilizing machine learning to generate future deposit transaction activity predictions in accordance with one or more implementations.

FIG. 14 illustrates a block diagram of an exemplary computing device in accordance with one or more implementations.

FIG. 15 illustrates an example environment for an inter-network facilitation system in accordance with one or more implementations.

### DETAILED DESCRIPTION

This disclosure describes one or more embodiments of systems, computer-implemented methods, and non-transitory computer readable media that provide benefits and solve one or more of the following mentioned or other problems by utilizing a machine learning classification model to generate deposit transaction activity predictions. Indeed, the disclosure describes one or more embodiments of a digital transaction activity detection system that utilizes a digital activity stream to identify user accounts that have inactivated deposit transaction activities. In addition, in one or more implementations, the digital transaction activity detection system utilizes a machine learning classification model to generate a predicted classification label to indicate whether a user account is likely to reactive deposit transaction activities. Moreover, the digital transaction activity detection system can dynamically initiate one or more downstream electronic tasks for deposit transaction reactivation based on the predicted classification label indicating whether the user account will reactivate future deposit transaction activities.

For instance, the digital transaction activity detection system can utilize a deposit transaction inactivity detection model to identify user accounts with inactivated deposit transaction activities. Indeed, the digital transaction activity detection system can identify digital activity data for user accounts from a digital activity data stream, such as, but not limited to digital deposit transaction data and/or user account data. In addition, the digital transaction activity detection system can utilize threshold metrics corresponding to deposit transaction activities to identify inactive deposit transaction user accounts (e.g., user accounts with inactivated deposit transaction activities). For example, the digital transaction activity detection system can compare digital deposit transaction amounts and times from a user account to threshold times and threshold transaction amounts to identify a user account with an inactivated deposit transaction activity.

Furthermore, the digital transaction activity detection system can utilize a machine learning classification model to generate deposit transaction activity predictions. In particular, the digital transaction activity detection system can generate a predicted probability of a user account reactivating deposit transaction activities by utilizing the machine learning classification model with one or more user account features corresponding to the user account. Indeed, in one or more embodiments, the digital transaction activity detection system determines a predicted classification label to indicate future deposit transaction activity or future deposit transaction inactivity for the user account based on the one or more user account features.

In addition, the digital transaction activity detection system can dynamically select and initiate a downstream electronic task for deposit transaction reactivation based on the predicted classification label indicating whether the user account will reactivate future deposit transaction activities. For example, based on the predicted classification label indicating the future deposit transaction activity for the user account, the digital transaction activity detection system can transmit an electronic communication to the user account. For instance, the transmitted electronic communication can provide, for display within a graphical user interface of a client device, a selectable option to initiate a deposit transaction activity. In some implementations, the digital transaction activity detection system can utilize the future deposit transaction activity reactivation prediction (e.g., the predicted classification label) to initiate various downstream electronic tasks, such as, but not limited to, electronic communication transmissions for the user account, modifying electronic communication allocations to the user account, detecting user account feature importance, and/or electronic communication response prioritization for the user account.

Recent years have seen a significant development in systems utilizing web-based and mobile-based applications to manage user accounts and digital information for user accounts in real (or near-real) time. Oftentimes, various conventional systems attempt to transform and utilize digital information of user accounts to enable functionalities for determining or calculating transactions from digital information via the web-based and mobile-based applications. Indeed, many conventional systems attempt to utilize digital information of user accounts to initiate targeted functions or electronic tasks for user accounts, however such conventional systems face a number of technical shortcomings, particularly with regard to inaccuracies of determined transaction information, inflexible functions, and inefficient graphical user interfaces that enable limited functionalities from the transformable data.

For example, conventional systems oftentimes cannot determine accurate future behavioral data of user accounts. In particular, many conventional systems are unable to accurately determine whether a user account is likely to interact or cease interactions with a particular transaction. Indeed, in many cases, conventional systems focus on predicting the presence of a future transaction activity. This often does not accurately capture predictions for user accounts resuming specific transaction activities.

In addition, many conventional systems oftentimes fail to robustly (or flexibly) transform transaction data of a user account to enable functionalities from the deposit transaction data. In particular, many conventional systems cannot utilize deposit transaction data to provide a targeted set of functionalities to a user account. Indeed, in many cases, conventional systems often rigidly perform a variety of tasks for user accounts when the user accounts often do not require the electronic tasks. Indeed, in many cases, conventional systems excessively surface and/or display functionalities to assist a user account setup a particular transaction activity when the user account may not require the functionalities to setup the particular transaction activity.

In addition to limited flexibility, conventional systems are also inefficient. For example, by rigidly performing a variety of tasks for user accounts blindly without targeting the functionalities based on predicted deposit transaction data, many conventional systems often inefficiently utilize computational resources to execute the tasks for the user accounts. In particular, in many instances, conventional systems initiate electronic tasks to a substantial number of user accounts to surface and/or display functionalities to assist particular user accounts setup a particular transaction activity when each user account may not require the functionalities to setup the particular transaction activity such that the conventional systems utilize computational resources inefficiently.

The digital transaction activity detection system can provide numerous technical advantages, benefits, and practical applications to relative conventional systems. For instance, in contrast to conventional systems that fail to accurately determine future behavioral data of user accounts, the digital transaction activity detection system can utilize deposit transaction reactivation predictions utilizing user account features with a machine learning classification model that accurately indicate whether user accounts will reactive a deposit transaction activity. Indeed, in one or more instances, the digital transaction activity detection system trains the machine learning classification model utilizing validation data that includes user account transaction activity (with ground truth labels indicating future deposit transaction activation and/or reactivation data) to accurately predict user accounts that are unlikely to reactivate deposit transaction activities on the inter-network facilitation system.

In addition, unlike many conventional systems that rigidly perform a variety of tasks for user accounts when the user accounts often do not require the electronic tasks, the digital transaction activity detection system improve flexibility by utilizing machine learning classification model deposit transaction reactivation predictions for user accounts to target user accounts identified as unlikely to reactivate deposit transaction activities on the inter-network facilitation system. Accordingly, the digital transaction activity detection system can dynamically select and provide functionalities to assist a user account setup a particular transaction activity when the user account is predicted to remain inactive in deposit transaction activities (and, therefore, benefit from additional functionalities to assist the user account in reactivating deposit transaction activities).

Moreover, unlike many inefficient conventional systems, the digital transaction activity detection system improves computational efficiency by reducing the number of electronic tasks for deposit transaction reactivation transmitted to user accounts. Indeed, by dynamically selecting and providing functionalities to assist a user account setup a particular transaction activity when the user account is predicted to remain inactive in deposit transaction activities, the digital transaction activity detection system efficiently targets the execution of electronic reactivation tasks. In one or more instances, the digital transaction activity detection system accurately targets electronic reactivation tasks to reduce the utilization of computational resources while also increasing the utilization of the reactivation tasks from targeted user accounts.

As used herein, the term “deposit transaction” (sometimes referred to as electronic deposit transaction) refers to a network transaction event in which a monetary value is instructed to be added to a user account of an inter-network facilitation network (as described herein). For example, a deposit transaction can include a direct deposit transaction corresponding to a user account of an inter-network facilitation network. In some instances, a deposit transaction can include reoccurring transactions in which a monetary value is added to a user account.

In addition, the term “deposit transaction inactivity” refers to a pause or cessation of deposit transactions within a user account. For example, the digital transaction activity detection system 106 can identify deposit transaction inactivity when a user account that included deposit transaction activities does not continue to have deposit transactions after a threshold period of time. Indeed, in one or more embodiments, the term “future deposit transaction activity” refers to a predicted presence of a deposit transaction activity (or reactivation of deposit transaction activity) within a user account. In addition, the term “future deposit transaction inactivity” refers to a predicted absence of deposit transaction activity within a user account.

As used herein, the term “machine learning classification model” refers to a model that determines (and/or outputs) classification labels to indicate whether a user account will reactivate paused deposit transactions in the future (e.g., future deposit transaction activity or inactivity) from user account features. For instance, a machine learning classification model can determine probability scores for a future deposit transaction activity label and a future deposit transaction inactivity label. For example, a machine learning classification model can include, but is not limited to, a binary classification model, multi-label classification model, logistic regression models, decision trees, gradient boosting models, and/or categorical data-based gradient boosting models.

As used herein, the term “machine learning model” refers to a computer model that can be trained (e.g., tuned or learned) based on inputs to approximate unknown functions and corresponding outputs. As an example, a machine learning model can include, but is not limited to, a neural network (e.g., a convolutional neural network, recurrent neural network, or deep learning model), a decision tree (e.g., a gradient boosted decision tree, a random forest decision tree, a decision tree with variable or output probabilities), and/or a support vector machine.

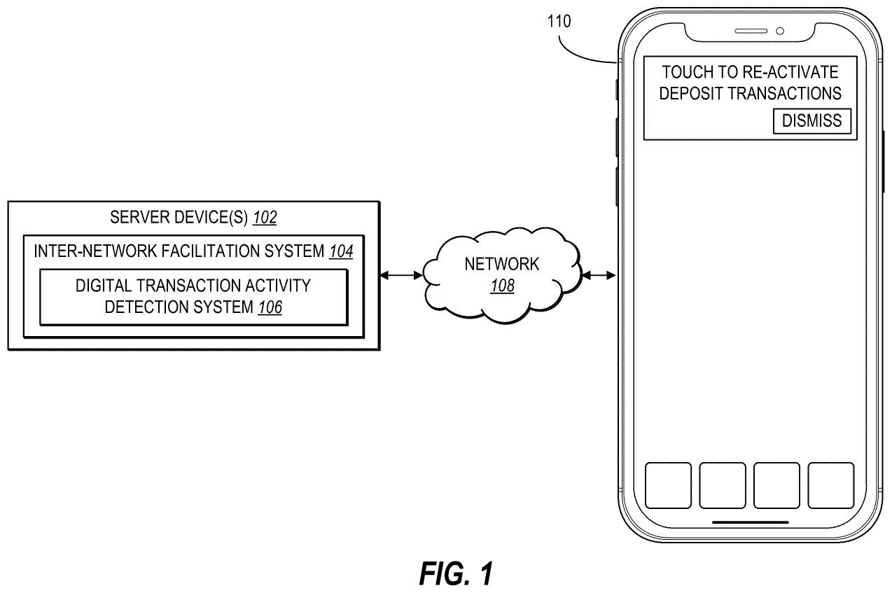

As used herein, the term “user account features” (sometimes referred to as user account data) refers to information (or data) associated with interactions of a user within and/or in connection with an inter-network facilitation system (as described in FIG. 1). To illustrate, user account data can include, but is not limited to, utilization of an application, transaction activity within the user account (e.g., payments, setting changes, payment scheduling), deposit transactions (e.g., deposit times, deposit amounts, deposit types), application feature utilization, interactions with technical support, user account values, fraud scores, client device data (e.g., geo-location data, phone number data), withdrawal transactions, deposit transaction source information (e.g., employer, account information for deposit transaction party, pay stub data), and/or user data (e.g., address, email address, employment, estimated income).

Turning now to the figures, FIG. 1 illustrates a block diagram of a system 100 (or system environment) for implementing an inter-network facilitation system 104 and a digital transaction activity detection system 106 in accordance with one or more embodiments. As shown in FIG. 1, the system 100 includes server device(s) 102 (which includes the inter-network facilitation system 104 and the digital transaction activity detection system 106) and a client device 110. As further illustrated in FIG. 1, the server device(s) 102 and the client device 110 can communicate via the network 108.

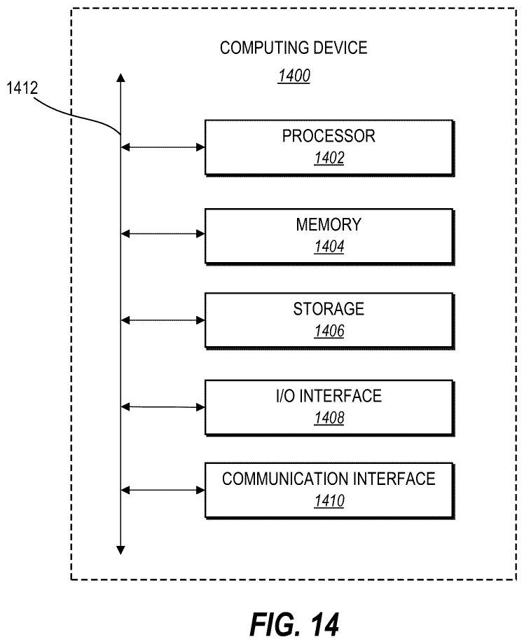

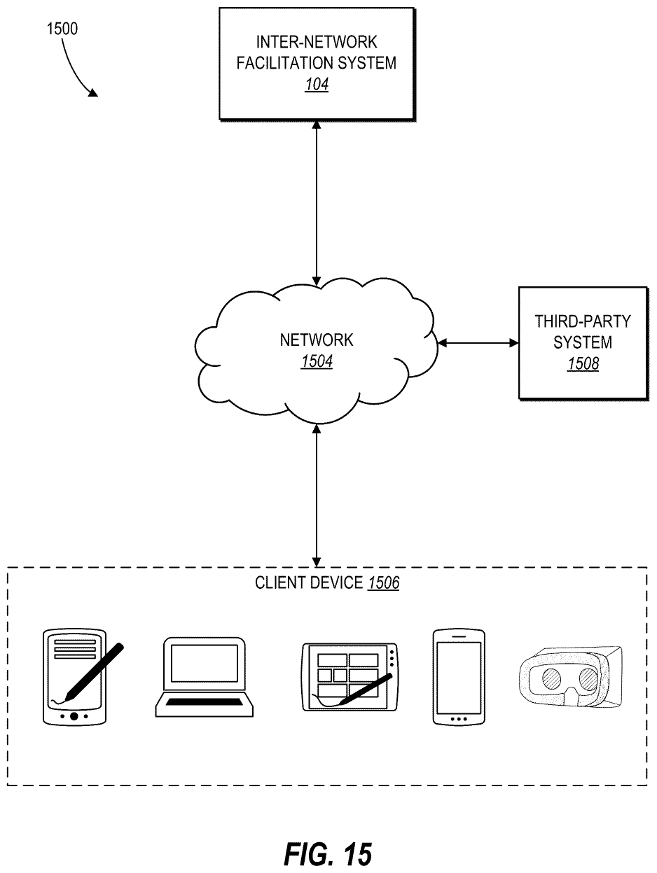

Although FIG. 1 illustrates the digital transaction activity detection system 106 being implemented by a particular component and/or device within the system 100, the digital transaction activity detection system 106 can be implemented, in whole or in part, by other computing devices and/or components in the system 100 (e.g., the client device 110). Additional description regarding the illustrated computing devices (e.g., the server device(s) 102, computing devices implementing the digital transaction activity detection system 106, the client device 110, an administrator device, and/or the network 108) is provided with respect to FIGS. 14 and 15 below.

As shown in FIG. 1, the server device(s) 102 can include the inter-network facilitation system 104. In some embodiments, the inter-network facilitation system 104 can determine, store, generate, and/or display financial information corresponding to a user account (e.g., a banking application, a money transfer application). Furthermore, the inter-network facilitation system 104 can also electronically communicate (or facilitate) financial transactions between one or more user accounts (and/or computing devices). Moreover, the inter-network facilitation system 104 can also track and/or monitor financial transactions and/or financial transaction behaviors of a user within a user account.

The inter-network facilitation system 104 can include a system that comprises the digital transaction activity detection system 106 and that facilitates financial transactions and digital communications across different computing systems over one or more networks. For example, the inter-network facilitation system 104 manages credit accounts, secured accounts, and other accounts for one or more accounts registered within the inter-network facilitation system 104. In some cases, the inter-network facilitation system 104 is a centralized network system that facilitates access to online banking accounts, credit accounts, and other accounts within a central network location. Indeed, the inter-network facilitation system 104 can link accounts from different network-based financial institutions to provide information regarding, and management tools for, the different accounts.

In one or more instances, the digital transaction activity detection system 106 utilizes a machine learning classification model to generate deposit transaction activity predictions to dynamically initiate downstream electronic tasks for deposit transaction reactivation. For example, the digital transaction activity detection system 106 can identify that a user account associated with the client device 110, through a user activity data stream, is an inactive deposit transaction user account. Furthermore, the digital transaction activity detection system 106 (in accordance with one or more implementations) can utilize user account features of the user account with a machine learning classification model to generate deposit transaction reactivation predictions for the user account (e.g., to determine whether the user account will reactivate deposit transactions). Moreover, the digital transaction activity detection system 106 (in accordance with one or more embodiments here) can transmit electronic communications to the client device 110 (e.g., an electronic notification with a selectable option to initiate deposit transactions) based on the deposit transaction reactivation prediction indicating that the user account is not likely to reactivate deposit transactions in the future.

Furthermore, although not shown in FIG. 1, the system 100 can include one or more data sources. For example, the one or more data sources can manage and/or store various data (e.g., user account features, user account activity data stream, machine learning prediction data, machine learning parameter data) for the inter-network facilitation system 104, the client device 110, and/or an administrator device. Indeed, the one or more data sources can include various data services or data repositories (e.g., via hardware and/or software) that manage data storage via cloud-based services and/or other networks (e.g., offline data stores, online data stores).

As also shown in FIG. 1, the system 100 also includes the client device 110. In certain instances, the client device 110 may include, but is not limited to, a mobile device (e.g., smartphone, tablet) or other type of computing device, including those explained below with reference to FIGS. 14 and 15. Additionally, the client device 110 can include a computing device associated with (and/or operated by) a user corresponding to a user account for the inter-network facilitation system 104. Moreover, the system 100 can include various numbers of client devices that communicate and/or interact with the inter-network facilitation system 104 and/or the digital transaction activity detection system 106.

In certain instances, the client device 110 corresponds to one or more user accounts (e.g., user accounts stored at the server device(s) 102). For instance, a user of a client device can establish a user account with login credentials and various information corresponding to the user. In addition, the user accounts can include a variety of information regarding financial information and/or financial transaction information for users (e.g., name, telephone number, address, bank account number, credit amount, debt amount, financial asset amount), payment information (e.g., account numbers), transaction history information, and/or contacts for financial transactions. In some embodiments, a user account can be accessed via multiple devices (e.g., multiple client devices) when authorized and authenticated to access the user account within the multiple devices. Moreover, the client device 110 can, via a user account, access financial information, initiate a financial transaction (e.g., transfer money to another account, deposit money, withdraw money), and/or access or provide data (to the server device(s) 102).

The present disclosure utilizes client devices to refer to devices associated with such user accounts. In referring to a client (or user) device, the disclosure and the claims are not limited to communications with a specific device, but any device corresponding to a user account of a particular user. Accordingly, in using the term client device, this disclosure can refer to any computing device corresponding to a user account of the inter-network facilitation system 104.

As further shown in FIG. 1, the system 100 includes the network 108. As mentioned above, the network 108 can enable communication between components of the system 100. In one or more embodiments, the network 108 may include a suitable network and may communicate using a various number of communication platforms and technologies suitable for transmitting data and/or communication signals, examples of which are described with reference to FIG. 15. Furthermore, although FIG. 1 illustrates the server device(s) 102 and the client device 110 communicating via the network 108, the various components of the system 100 can communicate and/or interact via other methods (e.g., the server device(s) 102 and the client device 110 can communicate directly).

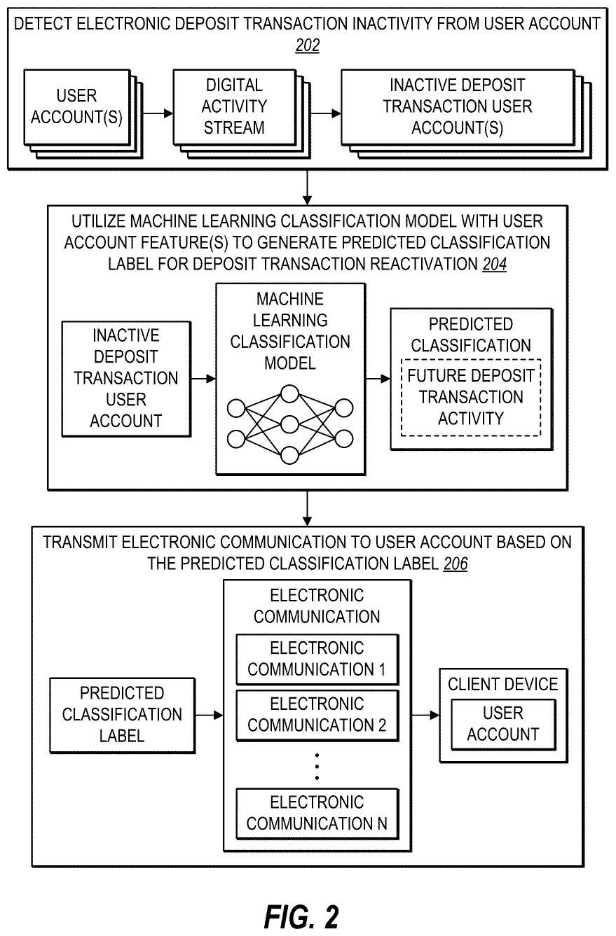

As mentioned above, the digital transaction activity detection system 106 can dynamically initiate one or more electronic tasks for deposit transaction reactivation based on a deposit transaction activity prediction from a machine learning classification model. For instance, FIG. 2 illustrates an overview of the digital transaction activity detection system 106 utilizing a machine learning classification model to generate deposit transaction activity predictions and dynamically initiating one or more electronic tasks for deposit transaction reactivation based on the predicted classification label. In particular, FIG. 2 illustrates the digital transaction activity detection system 106 detecting electronic deposit transaction inactivity from a user account, utilizing a machine learning classification model with user account feature(s) to generate a predicted classification label for deposit transaction reactivation, and transmitting an electronic communication to the user account based on the predicted classification label.

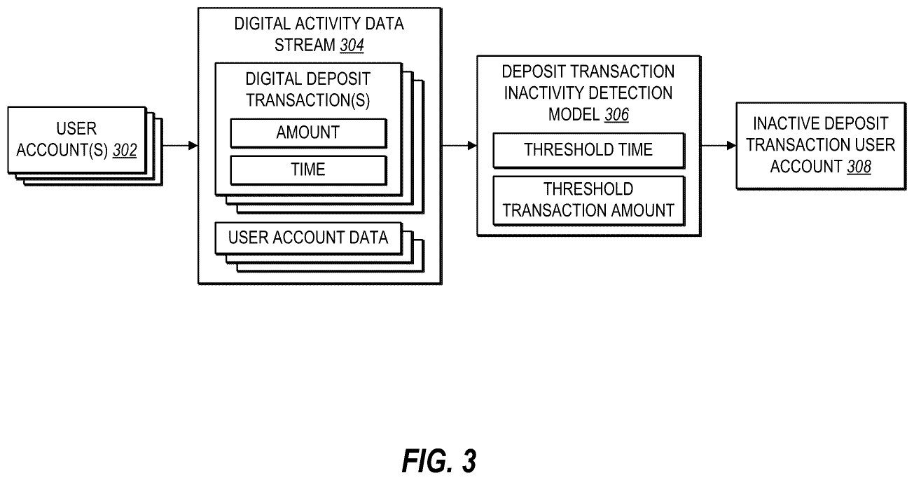

To illustrate, as shown in an act 202 of FIG. 2, the digital transaction activity detection system 106 detects electronic deposit transaction inactivity from a user account. For instance, the digital transaction activity detection system 106 can utilize a digital activity stream to identify digital transaction activity data for a user account. In addition, the digital transaction activity detection system 106 can utilize the digital transaction activity data with digital transaction activity thresholds to identify a user account that have inactivated deposit transaction activities. Indeed, the digital transaction activity detection system 106 detecting electronic deposit transaction inactivity from a user account is described in greater detail below (e.g., in reference to FIG. 3).

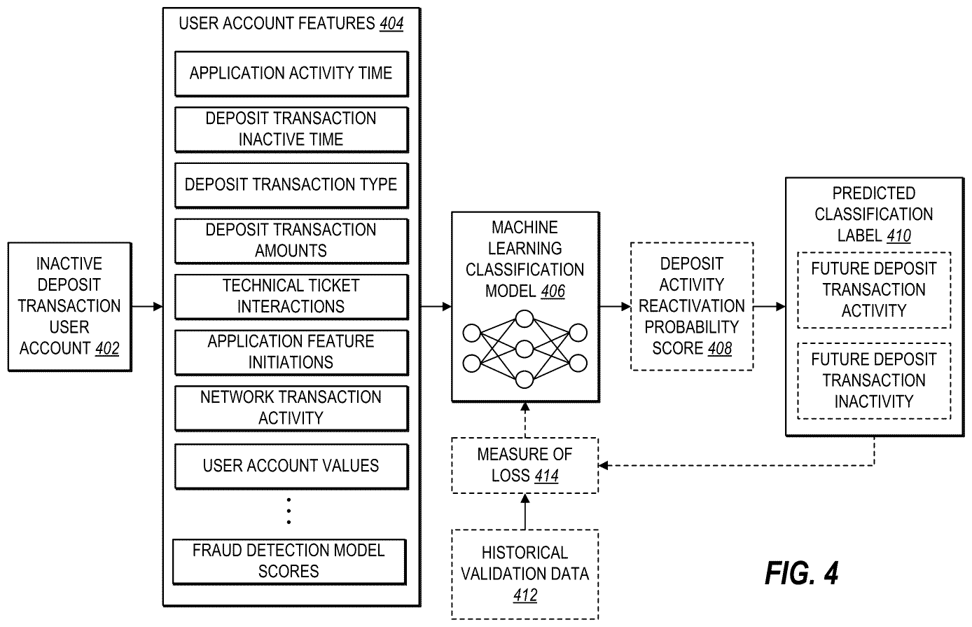

Moreover, as shown in an act 204 of FIG. 2, the digital transaction activity detection system 106 utilizes a machine learning classification model with user account feature(s) to generate a predicted classification label for deposit transaction reactivation. For instance, as shown in the act 204, the digital transaction activity detection system 106 can utilize user account features corresponding to the inactive deposit transaction user account with a machine learning classification model to generate a predicted classification label that indicates future deposit transaction activity. In particular, the digital transaction activity detection system 106 can generate a predicted classification label that indicates whether the user account will reactivate future deposit transaction activities. Indeed, the digital transaction activity detection system 106 generating deposit transaction reactivation predictions for a user account is described in greater detail below (e.g., in reference to FIG. 4).

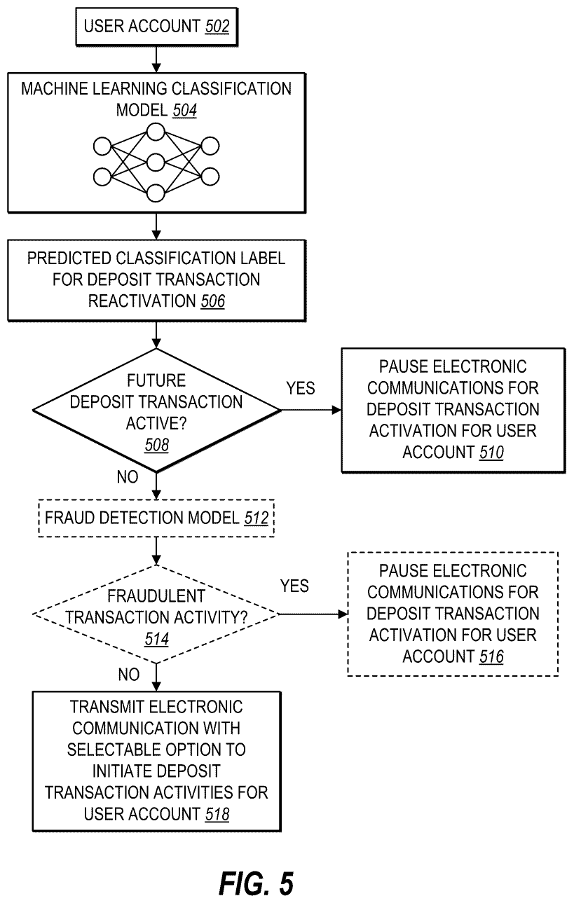

Furthermore, as shown in an act 206 of FIG. 2, the digital transaction activity detection system 106 transmits electronic communications to the user account based on the predicted classification label. For instance, as shown in the act 206, the digital transaction activity detection system 106 can dynamically configure and/or select an electronic communication (e.g., content of the electronic communication, interactive options within the electronic communication, type of electronic communication, and/or frequency of the transmission) to transmit to a client device (of the user account) based on the predicted classification label. For instance, based on determining that the user account is predicted to not activate deposit transactions in the future (i.e., predicted future deposit transaction inactivity), the digital transaction activity detection system 106 can transmit an electronic communication to the user account comprising a selectable option to initiate a deposit transaction activity within an inter-network facilitation system. Indeed, the digital transaction activity detection system 106 transmitting electronic communications to the user account (and/or initiating various other electronic tasks for the user account) based on the predicted classification label is described in greater detail below (e.g., in reference to FIGS. 5-8).

As mentioned above, the digital transaction activity detection system 106 can detect electronic deposit transaction inactivity from a user account. For instance, FIG. 3 illustrates the digital transaction activity detection system 106 detecting electronic deposit transaction inactivity from user accounts.

As shown in FIG. 3, the digital transaction activity detection system 106 identifies a digital activity data stream 304 from a user account(s) 302. Indeed, as shown in FIG. 3, the digital transaction activity detection system 106 identifies a digital deposit transaction(s) for a user account. In addition, as shown in FIG. 3, the digital transaction activity detection system 106 identifies digital deposit transaction amount(s) and digital deposit transaction event time(s) for the one or more digital deposit transaction(s) corresponding to the user account.

As further shown in FIG. 3, the digital transaction activity detection system 106 utilizes a deposit transaction inactivity detection model to determine electronic deposit transaction inactivity for the user account from the digital deposit transaction(s) (of the digital activity data stream 304). To illustrate, the digital transaction activity detection system 106 utilizes a threshold transaction amount to determine that a user account includes at least one previous deposit transaction activity that satisfies the threshold transaction amount (e.g., a candidate transaction activity). Furthermore, as shown in FIG. 3, the digital transaction activity detection system 106 compares a deposit transaction event time corresponding to the candidate deposit transaction activity to a threshold transaction event time. Indeed, the digital transaction activity detection system 106 determines that the user account is an inactive deposit transaction user account (e.g., an inactive deposit transaction user account 308) when the candidate transaction activity satisfies both the threshold transaction amount and the threshold transaction event time (e.g., a deposit transaction activity of a threshold amount that is older than a threshold transaction time, such as 30 days, 40 days, 2 months, etc.).

For example, the digital transaction activity detection system 106 can utilize a digital activity data stream to identify one or more user account transaction activities. For example, the digital activity data stream can include one or more network transaction activities on the inter-network facilitation system of the user account. In one or more implementations, the digital transaction activity detection system 106 identifies one or more deposit transaction activities within the inter-network facilitation system associated with the user account.

Moreover, in one or more instances, the digital transaction activity detection system 106 utilizes threshold transaction times and/or threshold transaction amounts to detect inactive deposit transaction user accounts. For example, the digital transaction activity detection system 106 can compare deposit transaction activity data (e.g., transaction times and amounts) to the threshold transaction times and/or threshold transaction amounts to identify that a user account is an inactive deposit transaction user account (e.g., a user account that has ceased deposit transaction activity). Indeed, the digital transaction activity detection system 106 can identify one or more deposit transactions corresponding to a user account that meets (or satisfies) a threshold transaction amount (e.g., a deposit transaction activity with a qualifying amount). Moreover, the digital transaction activity detection system 106 can determine whether the last (or latest) deposit transaction corresponding to the user account meet a threshold transaction time (e.g., to indicate that the threshold transaction is old and, therefore, inactive). Upon identifying that a latest deposit transaction activity (that meets threshold transaction amount) satisfies a threshold transaction time in relation to a user account, the digital transaction activity detection system 106 can label the user account as an inactive deposit transaction user account.

In some instances, the digital transaction activity detection system 106 can also utilize user account data (from the digital activity data stream 304) to determine (or detect) an inactive deposit transaction user account. For instance, the digital transaction activity detection system 106 can utilize user account data that indicates that the user account has inactivated deposit transaction activities within the user account. As an example, the digital transaction activity detection system 106 can identify user account data, such as, but not limited to, a user account setting selection, a digital action, and/or a user account notification indicating that the user account has inactivated deposit transaction activity.

As mentioned above, the digital transaction activity detection system 106 can utilize a machine learning classification model to generate deposit transaction reactivation predictions. For example, FIG. 4 illustrates the digital transaction activity detection system 106 utilizing a machine learning classification model to generate deposit transaction activity predictions. In particular, as shown in FIG. 4, the digital transaction activity detection system 106 identifies user account features 404 of an inactive deposit transaction user account (e.g., determined as described above). Moreover, the digital transaction activity detection system 106 utilizes the user account features 404 with a machine learning classification model 406 to generate a predicted classification label 410 to indicate that the inactive deposit transaction user account 402 is predicted to have future deposit transaction activity or future deposit transaction inactivity for the inactive deposit transaction user account 402.

In some cases, as shown in FIG. 4, the digital transaction activity detection system 106 utilizes the machine learning classification model 406 to generate a deposit activity reactivation probability score 408 for the inactive deposit transaction user account 402. Indeed, the digital transaction activity detection system 106 utilizes the deposit activity reactivation probability score 408 to determine a class (or label) for the inactive deposit transaction user account 402 indicating the future deposit transaction activity or future deposit transaction inactivity. For example, the digital transaction activity detection system 106 can compare deposit activity reactivation probability score 408 to a threshold probability score to determine whether the inactive deposit transaction user account 402 (through the user account features 404) belongs to the future deposit transaction activity class or future deposit transaction inactivity class.

In one or more instances, the digital transaction activity detection system 106 utilizes various combinations of user account features with the machine learning classification model to generate the deposit transaction reactivation predictions. For instance, as shown in FIG. 4, the digital transaction activity detection system 106 can utilize user account features, such as, but not limited to, application activity times, deposit transaction inactive times, deposit transaction types, deposit transaction amounts, technical ticket interactions, application feature initiations, network transaction activities, user account values, and/or fraud detection model scores.

For example, the digital transaction activity detection system 106 can utilize activity times with deposit transactions, user interactions within an application corresponding to the inter-network facilitation system, and/or user interactions with settings for network (or deposit) transactions on the inter-network facilitation system with the machine learning classification model to generate the deposit transaction reactivation predictions. In some cases, the digital transaction activity detection system 106 can utilize transaction data, such as, transaction type, transaction source, transaction frequency with the machine learning classification model to generate the deposit transaction reactivation predictions. Additionally, the digital transaction activity detection system 106 can utilize user interactions with the inter-network facilitation system, such as user interactions with an application of the inter-network facilitation system, technical ticket and/or support interactions, and/or application features utilization with the machine learning classification model to generate the deposit transaction reactivation predictions.

In some cases, the digital transaction activity detection system 106 can utilize deposit transaction metrics with the machine learning classification model to generate the deposit transaction reactivation predictions. For instance, the digital transaction activity detection system 106 can determine deposit transaction ratios that measure deposit transaction amount changes over time (e.g., as a deposit transaction velocity) as a user account feature. In addition, the digital transaction activity detection system 106 can utilize the deposit transaction velocity metrics with the machine learning classification model to generate the deposit transaction reactivation predictions.

In one or more implementations, the digital transaction activity detection system 106 utilizes partial deposit transaction data as a user account feature. For instance, the digital transaction activity detection system 106 can identify irregular deposit transactions from the user account (e.g., user account funding the account, refund transaction activities) as a user account feature. Indeed, the digital transaction activity detection system 106 can utilize the partial deposit transaction data with the machine learning classification model to generate the deposit transaction reactivation predictions.

In some instances, the digital transaction activity detection system 106 can also utilize historical deposit transaction reactivation activity as a user account feature. For example, the digital transaction activity detection system 106 can identify deposit transaction activities determined to be a deposit transaction reactivation activity (e.g., a deposit transaction activity that reactivates deposit transaction activities on an inactive deposit transaction user account). Indeed, the digital transaction activity detection system 106 can utilize the historical deposit transaction reactivation activity with the machine learning classification model to generate the deposit transaction reactivation predictions.

In one or more implementations, the digital transaction activity detection system 106 utilizes technical issue ticket interactions or other dispute ticket interactions from the user account as a user account feature. For instance, the digital transaction activity detection system 106 identifies one or more user account activities with a customer service agent, a ticket submission, and/or customer service chat bot to identify one or more disputes on the user account. Moreover, the digital transaction activity detection system 106 can utilize the technical issue ticket interactions or other dispute ticket interactions with the machine learning classification model to generate the deposit transaction reactivation predictions. Furthermore, the digital transaction activity detection system 106 can also identify feedback of the user account with technical issue ticket interactions or other dispute ticket interactions (e.g., chat bot experiences feedback, customer service agent experiences feedback) with the machine learning classification model to generate the deposit transaction reactivation predictions.

In some implementations, the digital transaction activity detection system 106 utilizes a variety of network transactions as a user account feature. For example, the digital transaction activity detection system 106 can utilize network transactions, such as, but not limited to, credit card transaction activity, debit card transaction activity, and/or online funding activity as a user account feature. In some instances, the digital transaction activity detection system 106 can also utilize a number of network transactions (and/or deposit transactions) as a user account feature. Indeed, the digital transaction activity detection system 106 can utilize the one or more network transactions with the machine learning classification model to generate the deposit transaction reactivation predictions.

In some instances, the digital transaction activity detection system 106 can utilize user account transaction inactivity (and/or reactivation) predictions as a user account feature. For example, the digital transaction activity detection system 106 can identify, from a machine learning model, a prediction indicating whether a user account will cease network transactions as a user account feature. In addition, the digital transaction activity detection system 106 can identify, from a machine learning model, a prediction indicating whether a user will reactivate (or resume) network transactions as a user account feature.

In one or more instances, the digital transaction activity detection system 106 can also utilize selectable options (or other communications) generated (or planned) for a user account as a user account feature. For instance, the digital transaction activity detection system 106 can identify selectable options and/or other communications planned for the user account to assist the user account reactivate deposit transaction activity. Moreover, the digital transaction activity detection system 106 can utilize the identified selectable options and/or other communications with the machine learning classification model to generate the deposit transaction reactivation predictions.

Furthermore, the digital transaction activity detection system 106 can also utilize user account application feature utilizations as user account features. In particular, the digital transaction activity detection system 106 can identify one or more application features utilized by the user account (e.g., one or more products, features, and/or settings available on the application of the inter-network facilitation system). Moreover, the digital transaction activity detection system 106 can utilize the user account utilization of the one or more application features with the machine learning classification model to generate the deposit transaction reactivation predictions.

In some instances, the digital transaction activity detection system 106 can utilize a user account inactivation prediction as a user account feature. For example, the digital transaction activity detection system 106 can, via a machine learning model of the inter-network facilitation system that predicts (or generates predictions for) a likelihood that a user account will be inactive as a user account feature. For instance, the digital transaction activity detection system 106 can utilize the predicted user account inactivation prediction with the machine learning classification model to generate the deposit transaction reactivation predictions.

In one or more implementations, the digital transaction activity detection system 106 utilizes user interface navigations corresponding to a user account as a user account feature. For example, the digital transaction activity detection system 106 can identify a number of user interface navigations corresponding to a user account that demonstrate a number of times the user account viewed various user interfaces, such as a deposit transaction setup user interface and/or a network transaction interface. Moreover, the digital transaction activity detection system 106 can utilize the user interface navigation data with the machine learning classification model to generate the deposit transaction reactivation predictions.

Although FIG. 4 illustrates the digital transaction activity detection system 106 utilizing particular user account features, the digital transaction activity detection system 106 can utilize a variety of user account features corresponding to user accounts of the inter-network facilitation system with the machine learning classification model to generate deposit transaction reactivation predictions (in accordance with one or more implementations herein).

In addition, the digital transaction activity detection system 106 can train the machine learning classification model to generate deposit transaction reactivation predictions. For example, as shown in FIG. 4, the digital transaction activity detection system 106 can identify historical validation data 412 that includes user account features for user accounts with historical deposit transaction activity data. Indeed, the digital transaction activity detection system 106 can utilize historical validation data 412 corresponding to the inactive deposit transaction user account 402 that indicates that the inactive deposit transaction user account 402 reactivated (or did not reactivate) deposit transaction activities after becoming an inactive deposit transaction user account. For instance, the digital transaction activity detection system 106 can utilize the historical validation data 412 with the predicted classification label 410 of the inactive deposit transaction user account 402 to determine a measure of loss 414. For instance, the measure of loss 414 can indicate whether the predicted classification label 410 correctly or incorrectly predicts that the inactive deposit transaction user account 402 reactivated a deposit transaction activity. Furthermore, the digital transaction activity detection system 106 can utilize the measure of loss 414 to modify parameters of the machine learning classification model 406 (e.g., utilizing propagation). Indeed, the digital transaction activity detection system 106 can modify parameters of the machine learning classification model 406 to minimize a loss between predicted outputs and ground truth data.

In some instances, the digital transaction activity detection system 106 generates training and/or validation data for the machine learning classification model. For example, the digital transaction activity detection system 106 can sample user activity data over a time period to identify transaction activities for the user accounts. In addition, the digital transaction activity detection system 106 can identify user account features associated with the user accounts to generate a mapping between user account features and transaction activities of the user accounts. Indeed, the digital transaction activity detection system 106 can utilize transaction activities to identify user accounts that include one or more deposit transaction activities, an inactive period of time from deposit transaction activities, and deposit transaction reactivation activities. Moreover, the digital transaction activity detection system 106 can associate the user accounts that include the one or more deposit transaction activities, an inactive period of time from deposit transaction activities, and deposit transaction reactivation activities with a ground truth classification label for future deposit transaction activity. In addition, the digital transaction activity detection system 106 can also utilize transaction activities to identify user accounts that include one or more deposit transaction activities and an inactive period of time from deposit transaction activities without a reactivation (over a threshold period of time) and label such user accounts with a ground truth classification label for future deposit transaction inactivity.

Moreover, the digital transaction activity detection system 106 can compare predicted classification labels from the machine learning classification model for the user account features from the user account training data to the ground truth classification labels corresponding to the user account training data. In one or more instances, the digital transaction activity detection system 106 compares the predicted classification labels to the ground truth classification labels to generate various measures of loss to utilize to modify the parameters of the machine learning classification model. For example, the digital transaction activity detection system 106 can determine measures of loss, such as, but not limited to, a cross entropy loss, mean squared error, or mean absolute error.

In one or more embodiments, the digital transaction activity detection system 106 can dynamically initiate electronic communications with a user account based on deposit transaction reactivation predictions for the user account. For example, FIG. 5 illustrates a flow diagram of the digital transaction activity detection system 106 dynamically initiating electronic communications with a user account based on deposit transaction reactivation predictions for the user account. As shown in FIG. 5, the digital transaction activity detection system 106 utilizes user account features from a user account 502 (e.g., an inactive deposit transaction activity user account) with a machine learning classification model 504 to generate a predicted classification label for deposit transaction reactivation 506 (in accordance with one or more implementations herein).

Furthermore, as shown in FIG. 5, the digital transaction activity detection system 106 can determine whether the user account 502 will reactivate future deposit transaction activity (in an act 508) to dynamically select (or initiate) electronic communications for the user account. To illustrate, as shown in FIG. 5, the digital transaction activity detection system 106, if the digital transaction activity detection system 106 determines (in the act 508) that the user account 502 will activate future deposit transaction activities (e.g., “yes”), the digital transaction activity detection system 106 can dynamically pause electronic communications for deposit transaction activation to the user account (in an act 510).

Moreover, as shown in FIG. 5, if the digital transaction activity detection system 106 determines (in the act 508) that the user account 502 will not activate future deposit transaction activities (e.g., “no”), the digital transaction activity detection system 106 can dynamically transmit electronic communication with a selectable option to initiate deposit transaction activities for the user account (in an act 518). Indeed, the digital transaction activity detection system 106 can transmit electronic communications to a user account predicted to not reactivate deposit transaction activities with selectable options to provide quick and efficient access to options for initializing (or reinitializing) deposit transaction activities on the user account.

In some instances, as shown in FIG. 5, the digital transaction activity detection system 106 can also utilize a fraud detection model and deposit transaction reactivation predictions for the user account to dynamically select (or initiate) electronic communications for the user account. For example, as shown in FIG. 5, the digital transaction activity detection system 106 can utilize a fraud detection model 512 with user account activity data to determine that the user account is associated with fraudulent transaction activities.

In addition, as shown in an act 514 of FIG. 5, the digital transaction activity detection system 106 can determine whether the user account 502 is associated with fraudulent transaction activities from the fraud detection model (in an act 514) to dynamically select (or initiate) electronic communications for the user account. To illustrate, as shown in FIG. 5, the digital transaction activity detection system 106, if the digital transaction activity detection system 106 determines (in the act 514) that the user account 502 is associated with fraudulent transaction activities (e.g., “yes”), the digital transaction activity detection system 106 can dynamically pause electronic communications for deposit transaction activation to the user account (in an act 516). Moreover, as shown in FIG. 5, if the digital transaction activity detection system 106 determines (in the act 514) that the user account 502 is not associated with fraudulent transaction activities (e.g., “no”), the digital transaction activity detection system 106 can dynamically transmit electronic communication with the selectable option to initiate deposit transaction activities for the user account (in an act 518).

In one or more instances, the digital transaction activity detection system 106 utilizes a fraud detection model (e.g., a machine learning model and/or other computer model) to detect fraudulent transaction activities for a user account. Indeed, the digital transaction activity detection system 106 can utilize the fraud detection model to identify whether the user account (via transaction activities of the user account) likely includes one or more fraudulent activities. Indeed, the digital transaction activity detection system 106 can utilize the fraud detection model to determine whether a user account is associated with a fraudulent transaction activity. In one or more instances, the digital transaction activity detection system 106 can identify a fraudulent activity score corresponding to a user account (from a third-party fraud detection model).

In some cases, the digital transaction activity detection system 106 can identify various types of fraudulent activities corresponding to a user account. For instance, the digital transaction activity detection system 106 can identify that a user account is associated with one or more fraudulent dispute claims. Indeed, the digital transaction activity detection system 106 can utilize the identified fraudulent activities to dynamically select or initiate one or more electronic tasks for the user account (in accordance with one or more implementations herein).

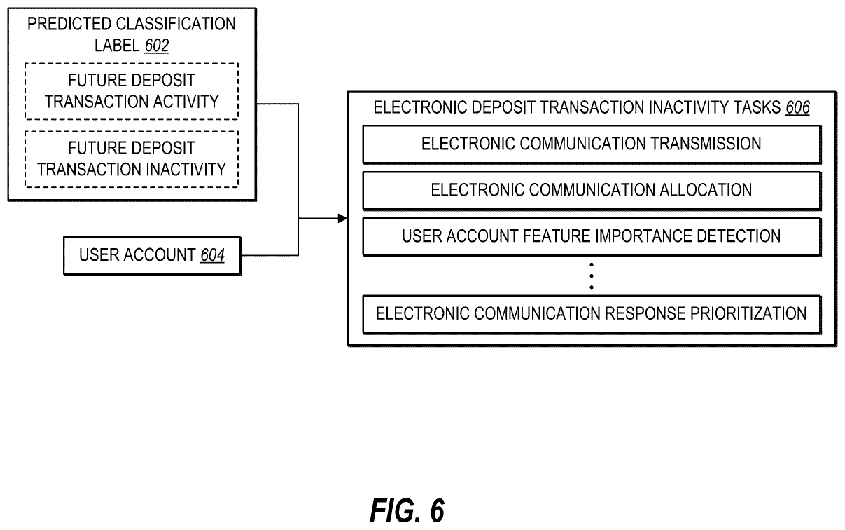

As also mentioned above, the digital transaction activity detection system 106 can dynamically initiate one or more downstream electronic tasks for deposit transaction reactivation based on the predicted classification label indicating whether the user account will reactivate future deposit transaction activities. For example, FIG. 6 illustrates the digital transaction activity detection system 106 dynamically initiating one or more downstream electronic tasks based on a deposit transaction reactivation prediction. In particular, FIG. 6 illustrates the digital transaction activity detection system 106 utilizing a user account 604 and a predicted classification label 602 associated with the user account 604 to dynamically select an electronic deposit transaction inactivity task from electronic deposit transaction inactivity tasks 606.

For example, the digital transaction activity detection system 106 can utilize a future deposit transaction inactivity prediction and/or a future deposit transaction activity prediction to dynamically select and/or execute various electronic deposit transaction inactivity tasks. For instance, the digital transaction activity detection system 106 can initiate one or more electronic deposit transaction tasks upon determining a future deposit transaction inactivity prediction for the user account. In some implementations, the digital transaction activity detection system 106 can pause and/or modify one or more electronic deposit transaction tasks upon determining a future deposit transaction activity prediction for the user account.

For instance, as shown in FIG. 6, the digital transaction activity detection system 106 can initiate (or execute) electronic communication transmissions as the electronic deposit transaction inactivity tasks 606. As an example, the digital transaction activity detection system 106 can forego and/or cease transmittal of electronic communications (to a client device of a user account) including selectable options and/or instructions to reactivate a deposit transaction activity upon determining that the user account is predicted to reactivate deposit transaction activities in the future. Furthermore, in some embodiments, the digital transaction activity detection system 106 transmits electronic communications (to a client device of a user account) with selectable options and/or instructions to reactivate a deposit transaction activity upon determining that the user account is predicted to not reactive deposit transaction activities in the future.

In some cases, as shown in FIG. 6, the digital transaction activity detection system 106 can modify an electronic communication allocation for a user account based on the future deposit transaction inactivity prediction and/or a future deposit transaction activity prediction. For example, based on the future deposit transaction inactivity prediction for the user account, the digital transaction activity detection system 106 can increase the electronic communication allocation for the user account to increase the transmittal frequency of electronic communications with selectable options and/or instructions to reactivate a deposit transaction activity. In addition, based on the future deposit transaction activity prediction for the user account (e.g., indicating that the user account is predicted to reactivate deposit transaction activities), the digital transaction activity detection system 106 can decrease the electronic communication allocation for the user account to decrease the transmittal frequency of electronic communications with selectable options and/or instructions to reactivate a deposit transaction activity.

In one or more embodiments, as shown in FIG. 6, the digital transaction activity detection system 106 can utilize the future deposit transaction reactivation prediction for user account feature importance detection. To illustrate, in one or more instances, the digital transaction activity detection system 106 can utilize the predicted classification labels for future deposit transaction reactivation from user accounts (with a particular set of user account features) to determine (or identify) user account features that affect future deposit transaction reactivation for a user account. For example, the digital transaction activity detection system 106 can identify user accounts corresponding to predicted future deposit transaction activity from the machine learning classification model. Furthermore, the digital transaction activity detection system 106 can identify user account features from the user accounts with the predicted future deposit transaction activity that relate to the future deposit transaction activity.

Moreover, the digital transaction activity detection system 106 can identify user account features from the user accounts that correspond to the predicted future deposit transaction inactivity. For example, the digital transaction activity detection system 106 can identify user accounts corresponding to predicted future deposit transaction inactivity from the machine learning classification model. In addition, the digital transaction activity detection system 106 can identify user account features from the user accounts with the predicted future deposit transaction inactivity that relate to the future deposit transaction inactivity.

In addition, as shown in FIG. 6, the digital transaction activity detection system 106 can utilize the future deposit transaction reactivation prediction to prioritize electronic communication responses for user accounts. As an example, the digital transaction activity detection system 106 can utilize the future deposit transaction reactivation predictions for user accounts (in accordance with one or more implementations herein) assign prioritizations to individual user accounts. In addition, upon receiving multiple electronic communications from user accounts (e.g., technical support calls, technical support messages), the digital transaction activity detection system 106 can response (or assign an agent for the response) to user accounts corresponding to the predicted future deposit transaction inactivity from the machine learning classification model. Indeed, the digital transaction activity detection system 106 can prioritize responses to electronic communications from the user accounts corresponding to the predicted future deposit transaction inactivity to increase a likelihood of the user accounts reactivating future deposit transaction activity.

Although FIG. 6 illustrates a number of downstream electronic tasks for deposit transaction reactivation, the digital transaction activity detection system 106 can dynamically select and/or initialize a variety of downstream electronic tasks for the user accounts utilizing the future deposit transaction reactivation predictions for the user accounts (in accordance with one or more implementations herein).

In some instances, the digital transaction activity detection system 106 can utilize the future deposit transaction reactivation predictions to dynamically select electronic communications that tie the modification of user account values corresponding to one or more application functions of the inter-network facilitation system to a deposit transaction reactivation. For example, the digital transaction activity detection system 106 can signal, within an electronic communication, that reactivation of the deposit transaction will cause an increase in an account value corresponding to one or more application functions of the inter-network facilitation system. For instance, the digital transaction activity detection system 106 can modify, utilizing the future deposit transaction reactivation predictions, one or more values corresponding to one or more application functions, such as a base-limit value as described in GENERATING USER INTERFACES COMPRISING DYNAMIC BASE LIMIT VALUE USER INTERFACE ELEMENTS DETERMINED FROM A BASE LIMIT VALUE MODEL, U.S. application Ser. No. 17/519,129, filed Nov. 4, 2021, an early available funds value as described in GENERATING GRAPHICAL USER INTERFACES COMPRISING DYNAMIC AVAILABLE DEPOSIT TRANSACTION VALUES DETERMINED FROM A DEPOSIT TRANSACTION PREDICTOR MODE, U.S. application Ser. No. 18/153,814, filed Jan. 12, 2023, and/or a resource accessibility option as described in INTERACTIVE DIALS WITHIN USER INTERFACES FOR RESOURCE ACCESSIBILITY, U.S. application Ser. No. 19/087,151, filed Mar. 21, 2025, each of which are incorporated by reference in their entirety herein.

Moreover, in in one or more implementations, the digital transaction activity detection system 106 utilizes model outputs from the machine learning classification model to target particular deciles of user accounts. For instance, the digital transaction activity detection system 106 can identify, utilizing a ranking order of user account deposit transaction reactivation probability, to identify one or more deciles of user accounts least likely to reactivate deposit transaction reactivations. Moreover, the digital transaction activity detection system 106 can target the downstream electronic tasks for deposit transaction reactivation to the identified deciles of user accounts.

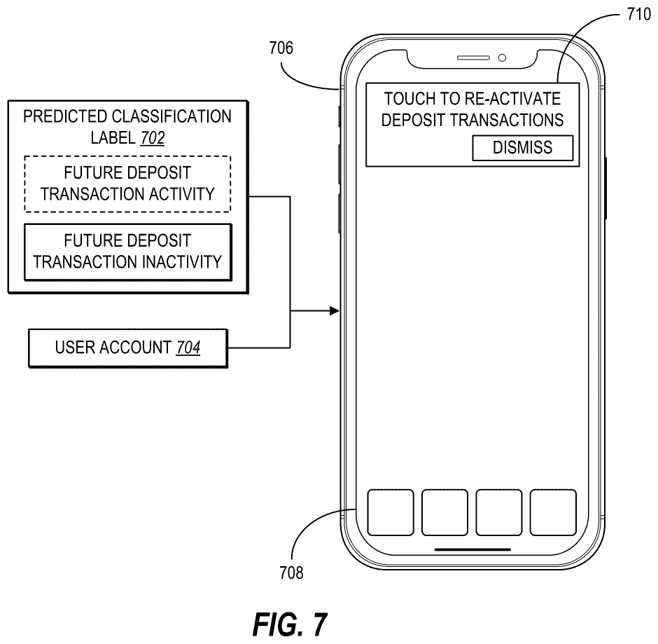

As mentioned above, the digital transaction activity detection system 106 can dynamically transmit an electronic communication to a client device of a user account based on a future deposit transaction reactivation prediction for the user account. For instance, FIG. 7 illustrates an example of the digital transaction activity detection system 106 transmitting an electronic communication to a user account based on future deposit transaction reactivation predictions for the user account.

Indeed, as shown in FIG. 7, the digital transaction activity detection system 106 utilizes a predicted classification label 702 for a user account 704 (in accordance with one or more implementations herein) to transmit an electronic communication to the user account 704. In particular, as shown in FIG. 7, the digital transaction activity detection system 106 can, in response to the predicted classification label 702 indicating future deposit transaction inactivity from the user account, transmit, to a client device corresponding to the user account, an electronic communication to the user account 704 comprising a selectable option to initiate a deposit transaction activity within the inter-network facilitation system.

For instance, as shown in FIG. 7, the digital transaction activity detection system 106 provides, for display within a graphical user interface 708 (e.g., a mobile device user interface) of a client device 706, an electronic notification 710 with a selectable option to initiate a deposit transaction activity reactivation for a user account within the inter-network facilitation system. Indeed, in reference to FIG. 7, the digital transaction activity detection system 106 can display an electronic notification 710 that is selectable (e.g., via a touch gesture on the electronic notification).

Upon detecting a touch gesture interaction within the client device 706, the digital transaction activity detection system 106 can directly (e.g., via a single user interaction) navigate to a graphical user interface to configure an electronic deposit transaction for the user account within the inter-network facilitation system. For example, the digital transaction activity detection system 106 can display one or more selectable options to configure, initiate, and/or schedule one or more electronic deposit transactions within the inter-network facilitation system.

Although FIG. 7 illustrates the digital transaction activity detection system 106 displaying an electronic notification, the digital transaction activity detection system 106 can transmit a variety of electronic communications, such as, but not limited to, emails, SMS messages, and/or instant messages.

In some instances, the digital transaction activity detection system 106 also provides, for display within a graphical user interface, one or more user account modifications (e.g., incentives) for initiating an electronic deposit transaction. For instance, the digital transaction activity detection system 106 can initiate (or introduce) a user account value to the user account (e.g., a bonus reward, a fee waiver) when user interactions are detected from the user account in relation to the selectable options to configure, initiate, and/or schedule one or more electronic deposit transactions within the inter-network facilitation system.

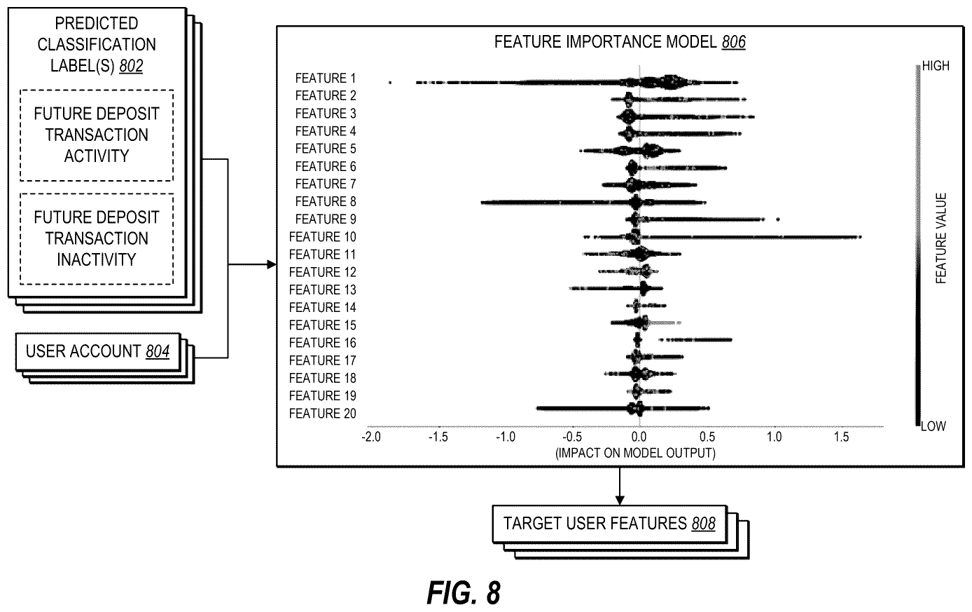

As mentioned above, in one or more instances, the digital transaction activity detection system 106 utilizes the future deposit transaction reactivation prediction for user account feature importance detection. For example, FIG. 8 illustrates the digital transaction activity detection system 106 utilizing future deposit transaction reactivation predictions to model and determine target user features that impact deposit transaction reactivation likelihoods for a user account. In particular, as shown in FIG. 8, the digital transaction activity detection system 106 utilizes a predicted classification label(s) 802 for user account(s) 804 generated from utilizing various user account features with a machine learning classification model with a feature importance model 806 to determine a user feature impact. For example, as shown in FIG. 8, the digital transaction activity detection system 106 can utilize a feature importance model 806 to model user account features (e.g., feature 1, feature 2, . . . , feature 20) impact on a machine learning classification model prediction for future deposit transaction reactivation predictions. In addition, the digital transaction activity detection system 106 can utilize the feature importance model 806 to identify a set of target user features 808 that correspond to future deposit transaction activity and/or future deposit transaction inactivity.

In some instances, the feature importance model utilizes global and/or local interpretability scores to determine user account feature impact on the future deposit transaction reactivation predictions. For example, the digital transaction activity detection system 106 can determine Shapley Additive Explanation (SHAP) values to explain an output of the machine learning classification model (e.g., the future deposit transaction reactivation predictions).

In some cases, the digital transaction activity detection system 106 utilizes the feature importance model to select one or more inputs for the machine learning classification model. In particular, the digital transaction activity detection system 106 can identify a threshold number of user account feature inputs that impact the future deposit transaction reactivation predictions (from the machine learning classification model). Indeed, in one or more instances, the digital transaction activity detection system 106 utilize the feature importance model to select one or more inputs for the machine learning classification model to reduce the number of data points utilized by the machine learning classification model to accurately generate a future deposit transaction reactivation prediction for a user account (e.g., by utilizing the threshold number of user account feature inputs).

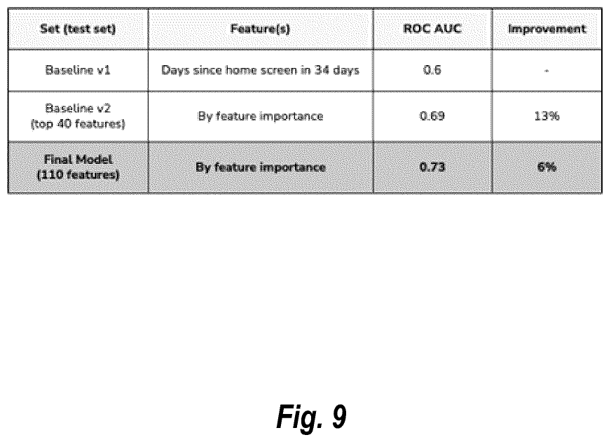

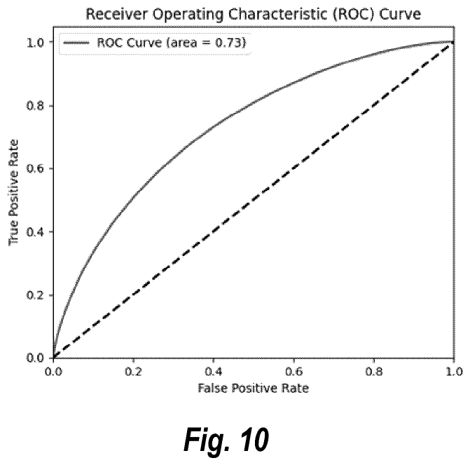

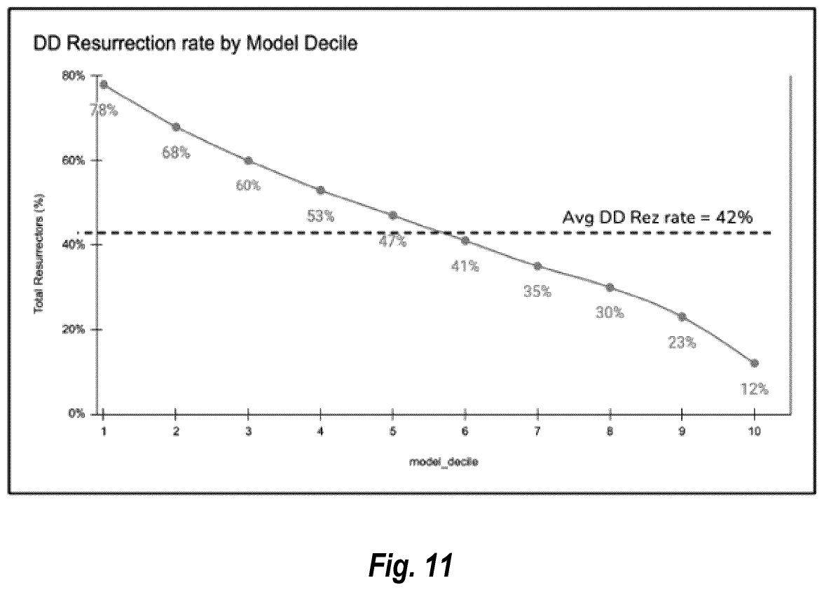

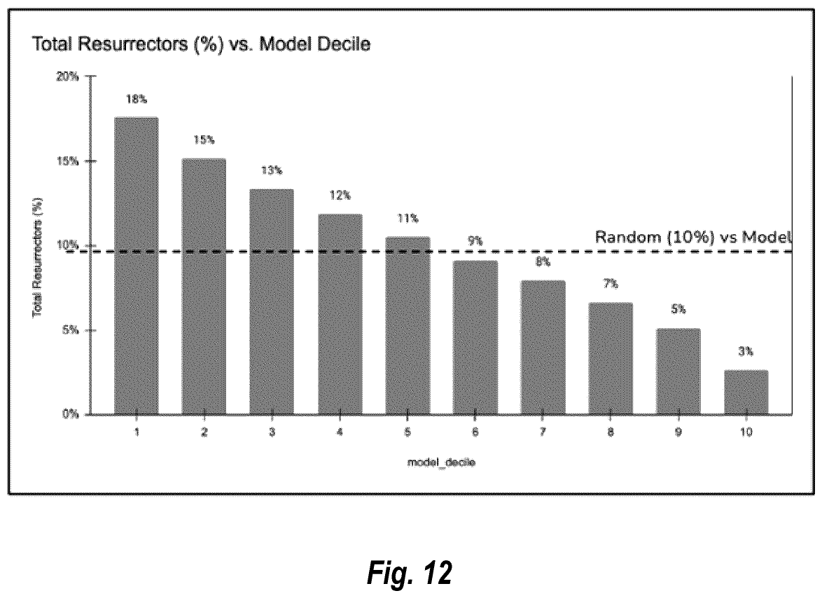

Indeed, experimenters conducted various experiments on an implementation of the digital transaction activity detection system. For example, FIGS. 9, 10, 11, and 12 demonstrate results from the conducted experiments. As an example, FIG. 9 illustrates improvement of accuracy results of utilizing an implementation of the machine learning classification model with different number of user account features (e.g., improving accuracy by utilizing feature importance to select a threshold of user account features). In addition, FIG. 10 illustrates an improvement of the ROC curve (for target ranking of user accounts using reactivation predictions from an implementation of the digital transaction activity detection system) compared to a random targeting (e.g., the dashed line). Furthermore, FIG. 11 illustrates, from an implementation of the digital transaction activity detection system utilized by experimenters, an improved deposit transaction resurrection rate using a machine learning classification model (in accordance with one or more implementations herein) against an average resurrection rate (e.g., showing strong rank ordering of the digital transaction activity detection system). Moreover, FIG. 12 illustrates, from an implementation of the digital transaction activity detection system utilized by experimenters, an improved deposit transaction resurrection rate using a machine learning classification model (in accordance with one or more implementations herein) against a resurrection rate from random targeting.

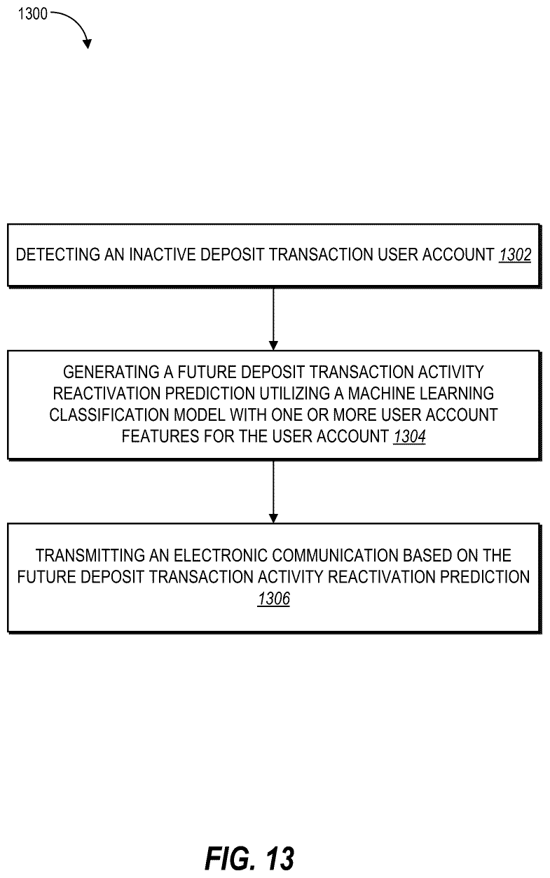

Turning now to FIG. 13, this figure shows a flowchart of a series of acts 1300 for utilizing machine learning to generate future deposit transaction activity predictions in accordance with one or more implementations. While FIG. 13 illustrates acts according to one embodiment, alternative embodiments may omit, add to, reorder, and/or modify any of the acts shown in FIG. 13. The acts of FIG. 13 can be performed as part of a method. Alternatively, a non-transitory computer readable storage medium can comprise instructions that, when executed by the one or more processors, cause a computing device to perform the acts depicted in FIG. 13. In still further embodiments, a system can perform the acts of FIG. 13.

As shown in FIG. 13, the series of acts 1300 include an act 1302 of detecting an inactive deposit transaction user account, an act 1304 of generating a future deposit transaction activity reactivation prediction utilizing a machine learning classification model with one or more user account features for the user account, and an act 1306 of transmitting an electronic communication based on the future deposit transaction activity reactivation prediction.

In some cases, the series of acts 1300 include detecting deposit transaction inactivity within an inter-network facilitation system from a user account for a threshold time period, generating, utilizing a machine learning classification model with one or more user account features, a predicted classification label indicating future deposit transaction activity or future deposit transaction inactivity for the user account, and, in response to the predicted classification label indicating the future deposit transaction inactivity from the user account, transmitting, to a client device corresponding to the user account, an electronic communication to the user account comprising a selectable option to initiate a deposit transaction activity within the inter-network facilitation system.

In addition, the series of acts 1300 can include identifying the user account with the detected deposit transaction activity by identifying, from historical transaction activity data from the user account, a historical deposit transaction event that satisfies a threshold deposit transaction amount and determining an event time of the historical deposit transaction event satisfies the threshold time period.

Moreover, the series of acts 1300 can include generating the predicted classification label by generating a probability score of a future deposit transaction at the user account by utilizing the machine learning classification model with the one or more user account features of the user account and selecting the predicted classification label indicating the future deposit transaction activity or the future deposit transaction inactivity for the user account by comparing the probability score to a threshold probability score.

Additionally, the series of acts 1300 can include utilizing the machine learning classification model with at least two of historical transaction activity data, historical deposit transaction transmission data, historical deposit transaction inactivity data, application interaction data, or user account technical ticket data to generate the predicted classification label.

In addition, the series of acts 1300 can include modifying, for the user account, a transmittal frequency of the electronic communication based on the predicted classification label indicating the future deposit transaction inactivity from the user account.

Moreover, the series of acts 1300 can include generating, utilizing a machine learning classification model with one or more additional user account features corresponding to an additional user, an additional predicted classification label for future deposit transaction activity of the additional user account, determining, utilizing a fraud detection model with the one or more additional user account features, a fraudulent transaction activity for the additional user account, and, in response to the additional predicted classification label indicating an additional future deposit transaction inactivity from the additional user account and the fraudulent transaction activity for the additional user account, pausing electronic communications, for the additional user account, comprising options to initiate deposit transaction activities within the inter-network facilitation system.

In some cases, the series of acts 1300 include generating, utilizing a machine learning classification model with one or more additional user account features corresponding to an additional user, an additional predicted classification label for future deposit transaction activity of the additional user account and, in response to the additional predicted classification label indicating an additional future deposit transaction activity from the additional user account, pausing electronic communications, for the additional user account, comprising options to initiate deposit transaction activities within the inter-network facilitation system.

Furthermore, the series of acts 1300 can include generating, utilizing a machine learning classification model with one or more additional user account features corresponding to an additional user, an additional predicted classification label for future deposit transaction activity of the additional user account and, in response to the additional predicted classification label indicating an additional future deposit transaction activity from the additional user account, pausing electronic communications, for the additional user account, comprising options to initiate deposit transaction activities within the inter-network facilitation system.

Moreover, the series of acts 1300 can include generating a set of training data comprising user account data and historical deposit transaction reactivation data, utilizing the machine learning classification model with the user account data to generate predicted deposit transaction reactivations, and modifying parameters of the machine learning classification model by comparing the predicted deposit transaction reactivations with the historical deposit transaction reactivation data.

In addition, the series of acts 1300 can include, in response to the predicted classification label indicating the future deposit transaction inactivity from the user account and receiving an electronic communication from the client device of the user account, reducing a response time for an electronic response to the electronic user communication.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 14 illustrates, in block diagram form, an exemplary computing device 1400 that may be configured to perform one or more of the processes described above. One will appreciate that the digital transaction activity detection system 106 (or the inter-network facilitation system 104) can comprise implementations of a computing device, including, but not limited to, the devices or systems illustrated in the previous figures. As shown by FIG. 14, the computing device can comprise a processor 1402, memory 1404, a storage device 1406, an I/O interface 1408, and a communication interface 1410. In certain embodiments, the computing device 1400 can include fewer or more components than those shown in FIG. 14. Components of computing device 1400 shown in FIG. 14 will now be described in additional detail.

In particular embodiments, processor(s) 1402 includes hardware for executing instructions, such as those making up a computer program. As an example, and not by way of limitation, to execute instructions, processor(s) 1402 may retrieve (or fetch) the instructions from an internal register, an internal cache, memory 1404, or a storage device 1406 and decode and execute them.

The computing device 1400 includes memory 1404, which is coupled to the processor(s) 1402. The memory 1404 may be used for storing data, metadata, and programs for execution by the processor(s). The memory 1404 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 1404 may be internal or distributed memory.

The computing device 1400 includes a storage device 1406 includes storage for storing data or instructions. As an example, and not by way of limitation, storage device 1406 can comprise a non-transitory storage medium described above. The storage device 1406 may include a hard disk drive (“HDD”), flash memory, a Universal Serial Bus (“USB”) drive or a combination of these or other storage devices.

The computing device 1400 also includes one or more input or output (“I/O”) interface 1408, which are provided to allow a user (e.g., requester or provider) to provide input to (such as user strokes), receive output from, and otherwise transfer data to and from the computing device 1400. These I/O interface 1408 may include a mouse, keypad or a keyboard, a touch screen, camera, optical scanner, network interface, modem, other known I/O devices or a combination of such I/O interface 1408. The touch screen may be activated with a stylus or a finger.

The I/O interface 1408 may include one or more devices for presenting output to a user, including, but not limited to, a graphics engine, a display (e.g., a display screen), one or more output providers (e.g., display providers), one or more audio speakers, and one or more audio providers. In certain embodiments, the I/O interface 1408 is configured to provide graphical data to a display for presentation to a user. The graphical data may be representative of one or more graphical user interfaces and/or any other graphical content as may serve a particular implementation.

The computing device 1400 can further include a communication interface 1410. The communication interface 1410 can include hardware, software, or both. The communication interface 1410 can provide one or more interfaces for communication (such as, for example, packet-based communication) between the computing device and one or more other computing devices 1400 or one or more networks. As an example, and not by way of limitation, communication interface 1410 may include a network interface controller (“NIC”) or network adapter for communicating with an Ethernet or other wire-based network or a wireless NIC (“WNIC”) or wireless adapter for communicating with a wireless network, such as a WI-FI. The computing device 1400 can further include a bus 1412. The bus 1412 can comprise hardware, software, or both that couples components of computing device 1400 to each other.

FIG. 15 illustrates an example network environment 1500 of the inter-network facilitation system 104. The network environment 1500 includes a client device 1506 (e.g., client device 110), an inter-network facilitation system 104, and a third-party system 1508 connected to each other by a network 1504. Although FIG. 15 illustrates a particular arrangement of the client device 1506, the inter-network facilitation system 104, the third-party system 1508, and the network 1504, this disclosure contemplates any suitable arrangement of client device 1506, the inter-network facilitation system 104, the third-party system 1508, and the network 1504. As an example, and not by way of limitation, two or more of client device 1506, the inter-network facilitation system 104, and the third-party system 1508 communicate directly, bypassing network 1504. As another example, two or more of client device 1506, the inter-network facilitation system 104, and the third-party system 1508 may be physically or logically co-located with each other in whole or in part.

Moreover, although FIG. 15 illustrates a particular number of client devices 1506, inter-network facilitation system 104, third-party systems 1508, and networks 1504, this disclosure contemplates any suitable number of client devices 1506, FIG. 15, third-party systems 1508, and networks 1504. As an example, and not by way of limitation, network environment 1500 may include multiple client devices 1506, inter-network facilitation system 104, third-party systems 1508, and/or networks 1504.

This disclosure contemplates any suitable network 1504. As an example, and not by way of limitation, one or more portions of network 1504 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 1504 may include one or more networks 1504.

Links may connect client device 1506, inter-network facilitation system 104 (e.g., which hosts the digital transaction activity detection system 106), and third-party system 1508 to network 1504 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1500. One or more first links may differ in one or more respects from one or more second links.

In particular embodiments, the client device 1506 may be an electronic device including hardware, software, or embedded logic components or a combination of two or more such components and capable of carrying out the appropriate functionalities implemented or supported by client device 1506. As an example, and not by way of limitation, a client device 1506 may include any of the computing devices discussed above in relation to FIG. 14. A client device 1506 may enable a network user at the client device 1506 to access network 1504. A client device 1506 may enable its user to communicate with other users at other client devices 1506.

In particular embodiments, the client device 1506 may include a requester application or a web browser, such as MICROSOFT INTERNET EXPLORER, GOOGLE CHROME, or MOZILLA FIREFOX, and may have one or more add-ons, plug-ins, or other extensions, such as TOOLBAR or YAHOO TOOLBAR. A user at the client device 1506 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 1506 one or more Hyper Text Markup Language (“HTML”) files responsive to the HTTP request. The client device 1506 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, inter-network facilitation system 104 may be a network-addressable computing system that can interface between two or more computing networks or servers associated with different entities such as financial institutions (e.g., banks, credit processing systems, ATM systems, or others). In particular, the inter-network facilitation system 104 can send and receive network communications (e.g., via the network 1504) to link the third-party-system 1508. For example, the inter-network facilitation system 104 may receive authentication credentials from a user to link a third-party system 1508 such as an online bank account, credit account, debit account, or other financial account to a user account within the inter-network facilitation system 104. The inter-network facilitation system 104 can subsequently communicate with the third-party system 1508 to detect or identify balances, transactions, withdrawal, transfers, deposits, credits, debits, or other transaction types associated with the third-party system 1508. The inter-network facilitation system 104 can further provide the aforementioned or other financial information associated with the third-party system 1508 for display via the client device 1506. In some cases, the inter-network facilitation system 104 links more than one third-party system 1508, receiving account information for accounts associated with each respective third-party system 1508 and performing operations or transactions between the different systems via authorized network connections.

In particular embodiments, the inter-network facilitation system 104 may interface between an online banking system and a credit processing system via the network 1504. For example, the inter-network facilitation system 104 can provide access to a bank account of a third-party system 1508 and linked to a user account within the inter-network facilitation system 104. Indeed, the inter-network facilitation system 104 can facilitate access to, and transactions to and from, the bank account of the third-party system 1508 via a client application of the inter-network facilitation system 104 on the client device 1506. The inter-network facilitation system 104 can also communicate with a credit processing system, an ATM system, and/or other financial systems (e.g., via the network 1504) to authorize and process credit charges to a credit account, perform ATM transactions, perform transfers (or other transactions) across accounts of different third-party systems 1508, and to present corresponding information via the client device 1506.

In particular embodiments, the inter-network facilitation system 104 includes a model for approving or denying transactions. For example, the inter-network facilitation system 104 includes a transaction approval machine learning model that is trained based on training data such as user account information (e.g., name, age, location, and/or income), account information (e.g., current balance, average balance, maximum balance, and/or minimum balance), credit usage, and/or other transaction history. Based on one or more of these data (from the inter-network facilitation system 104 and/or one or more third-party systems 1508), the inter-network facilitation system 104 can utilize the transaction approval machine learning model to generate a prediction (e.g., a percentage likelihood) of approval or denial of a transaction (e.g., a withdrawal, a transfer, or a purchase) across one or more networked systems.

The inter-network facilitation system 104 may be accessed by the other components of network environment 1500 either directly or via network 1504. In particular embodiments, the inter-network facilitation system 104 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by the server. In particular embodiments, the inter-network facilitation system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1506, or an inter-network facilitation system 104 to manage, retrieve, modify, add, or delete, the information stored in a data store.

In particular embodiments, the inter-network facilitation system 104 may provide users with the ability to take actions on various types of items or objects, supported by the inter-network facilitation system 104. As an example, and not by way of limitation, the items and objects may include financial institution networks for banking, credit processing, or other transactions, to which users of the inter-network facilitation system 104 may belong, computer-based applications that a user may use, transactions, interactions that a user may perform, or other suitable items or objects. A user may interact with anything that is capable of being represented in the inter-network facilitation system 104 or by an external system of a third-party system, which is separate from inter-network facilitation system 104 and coupled to the inter-network facilitation system 104 via a network 1504.

In particular embodiments, the inter-network facilitation system 104 may be capable of linking a variety of entities. As an example, and not by way of limitation, the inter-network facilitation system 104 may enable users to interact with each other or other entities, or to allow users to interact with these entities through an application programming interfaces (“API”) or other communication channels.

In particular embodiments, the inter-network facilitation system 104 may include a variety of servers, sub-systems, programs, modules, logs, and data stores. In particular embodiments, the inter-network facilitation system 104 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The inter-network facilitation system 104 may also include suitable components such as network interfaces, security mechanisms, load balancers, failover servers, management-and-network-operations consoles, other suitable components, or any suitable combination thereof. In particular embodiments, the inter-network facilitation system 104 may include one or more user-profile stores for storing user profiles for transportation providers and/or transportation requesters. A user profile may include, for example, biographic information, demographic information, financial information, behavioral information, social information, or other types of descriptive information, such as interests, affinities, or location.

The web server may include a mail server or other messaging functionality for receiving and routing messages between the inter-network facilitation system 104 and one or more client devices 1506. An action logger may be used to receive communications from a web server about a user's actions on or off the inter-network facilitation system 104. In conjunction with the action log, a third-party-content-object log may be maintained of user exposures to third-party-content objects. A notification controller may provide information regarding content objects to a client device 1506. Information may be pushed to a client device 1506 as notifications, or information may be pulled from client device 1506 responsive to a request received from client device 1506. Authorization servers may be used to enforce one or more privacy settings of the users of the inter-network facilitation system 104. A privacy setting of a user determines how particular information associated with a user can be shared. The authorization server may allow users to opt in to or opt out of having their actions logged by the inter-network facilitation system 104 or shared with other systems, such as, for example, by setting appropriate privacy settings. Third-party-content-object stores may be used to store content objects received from third parties. Location stores may be used for storing location information received from client devices 1506 associated with users.

In addition, the third-party system 1508 can include one or more computing devices, servers, or sub-networks associated with internet banks, central banks, commercial banks, retail banks, credit processors, credit issuers, ATM systems, credit unions, loan associates, brokerage firms, linked to the inter-network facilitation system 104 via the network 1504. A third-party system 1508 can communicate with the inter-network facilitation system 104 to provide financial information pertaining to balances, transactions, and other information, whereupon the inter-network facilitation system 104 can provide corresponding information for display via the client device 1506. In particular embodiments, a third-party system 1508 communicates with the inter-network facilitation system 104 to update account balances, transaction histories, credit usage, and other internal information of the inter-network facilitation system 104 and/or the third-party system 1508 based on user interaction with the inter-network facilitation system 104 (e.g., via the client device 1506). Indeed, the inter-network facilitation system 104 can synchronize information across one or more third-party systems 1508 to reflect accurate account information (e.g., balances, transactions, etc.) across one or more networked systems, including instances where a transaction (e.g., a transfer) from one third-party system 1508 affects another third-party system 1508.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

1. A computer-implemented method comprising:
detecting deposit transaction inactivity within an inter-network facilitation system from a user account for a threshold time period;
generating, utilizing a machine learning classification model with one or more user account features, a predicted classification label indicating future deposit transaction activity or future deposit transaction inactivity for the user account; and
in response to the predicted classification label indicating the future deposit transaction inactivity from the user account, transmitting, to a client device corresponding to the user account, an electronic communication to the user account comprising a selectable option to initiate a deposit transaction activity within the inter-network facilitation system.

2. The computer-implemented method of claim 1, further comprising identifying the user account with the detected deposit transaction inactivity by:
identifying, from historical transaction activity data from the user account, a historical deposit transaction event that satisfies a threshold deposit transaction amount; and
determining an event time of the historical deposit transaction event satisfies the threshold time period.

3. The computer-implemented method of claim 1, further comprising generating the predicted classification label by:
generating a probability score of a future deposit transaction at the user account by utilizing the machine learning classification model with the one or more user account features of the user account; and
selecting the predicted classification label indicating the future deposit transaction activity or the future deposit transaction inactivity for the user account by comparing the probability score to a threshold probability score.

4. The computer-implemented method of claim 1, further comprising utilizing the machine learning classification model with at least two of historical transaction activity data, historical deposit transaction transmission data, historical deposit transaction inactivity data, application interaction data, or user account technical ticket data to generate the predicted classification label.

5. The computer-implemented method of claim 1, further comprising modifying, for the user account, a transmittal frequency of the electronic communication based on the predicted classification label indicating the future deposit transaction inactivity from the user account.

6. The computer-implemented method of claim 1, further comprising:
generating, utilizing the machine learning classification model with one or more additional user account features corresponding to an additional user account, an additional predicted classification label for the future deposit transaction activity of the additional user account;
determining, utilizing a fraud detection model with the one or more additional user account features, a fraudulent transaction activity for the additional user account; and
in response to the additional predicted classification label indicating an additional future deposit transaction inactivity from the additional user account and the fraudulent transaction activity for the additional user account, pausing electronic communications, for the additional user account, comprising options to initiate deposit transaction activities within the inter-network facilitation system.

7. The computer-implemented method of claim 1, further comprising:
generating, utilizing the machine learning classification model with one or more additional user account features corresponding to an additional user account, an additional predicted classification label for the future deposit transaction activity of the additional user account; and
in response to the additional predicted classification label indicating an additional future deposit transaction activity from the additional user account, pausing electronic communications, for the additional user account, comprising options to initiate deposit transaction activities within the inter-network facilitation system.

8. The computer-implemented method of claim 1, further comprising:
generating a set of training data comprising user account data and historical deposit transaction reactivation data;
utilizing the machine learning classification model with the user account data to generate predicted deposit transaction reactivations; and
modifying parameters of the machine learning classification model by comparing the predicted deposit transaction reactivations with the historical deposit transaction reactivation data.

9. The computer-implemented method of claim 1, further comprising, in response to the predicted classification label indicating the future deposit transaction inactivity from the user account and receiving an electronic communication from the client device of the user account, reducing a response time for an electronic response to the electronic communication.

10. A non-transitory computer-readable medium storing instructions that, when executed by at least one processor, cause a computing device to:
detect deposit transaction inactivity within an inter-network facilitation system from a user account for a threshold time period;
generate, utilizing a machine learning classification model with one or more user account features, a predicted classification label indicating future deposit transaction activity or future deposit transaction inactivity for the user account; and
in response to the predicted classification label indicating the future deposit transaction inactivity from the user account, transmit, to a client device corresponding to the user account, an electronic communication to the user account comprising a selectable option to initiate a deposit transaction activity within the inter-network facilitation system.

11. The non-transitory computer-readable medium of claim 10, further comprising instructions that, when executed by the at least one processor, cause the computing device to identify the user account with the detected deposit transaction inactivity by:
identifying, from historical transaction activity data from the user account, a historical deposit transaction event that satisfies a threshold deposit transaction amount; and
determining an event time of the historical deposit transaction event satisfies the threshold time period.

12. The non-transitory computer-readable medium of claim 10, further comprising instructions that, when executed by the at least one processor, cause the computing device to generate the predicted classification label by:
generating a probability score of a future deposit transaction at the user account by utilizing the machine learning classification model with the one or more user account features of the user account; and
selecting the predicted classification label indicating the future deposit transaction activity or the future deposit transaction inactivity for the user account by comparing the probability score to a threshold probability score.

13. The non-transitory computer-readable medium of claim 10, further comprising instructions that, when executed by the at least one processor, cause the computing device to utilize the machine learning classification model with at least two of historical transaction activity data, historical deposit transaction transmission data, historical deposit transaction inactivity data, application interaction data, or user account technical ticket data to generate the predicted classification label.

14. The non-transitory computer-readable medium of claim 10, further comprising instructions that, when executed by the at least one processor, cause the computing device to modify, for the user account, a transmittal frequency of the electronic communication based on the predicted classification label indicating the future deposit transaction inactivity from the user account.

15. A system comprising:
at least one processor; and
at least one non-transitory computer-readable storage medium storing instructions that, when executed by the at least one processor, cause the system to:
detect deposit transaction inactivity within an inter-network facilitation system from a user account for a threshold time period;
generate, utilizing a machine learning classification model with one or more user account features, a predicted classification label indicating future deposit transaction activity or future deposit transaction inactivity for the user account; and
in response to the predicted classification label indicating the future deposit transaction inactivity from the user account, transmit, to a client device corresponding to the user account, an electronic communication to the user account comprising a selectable option to initiate a deposit transaction activity within the inter-network facilitation system.

16. The system of claim 15, further comprising instructions that, when executed by the at least one processor, cause the system to identify the user account with the detected deposit transaction inactivity by:
identifying, from historical transaction activity data from the user account, a historical deposit transaction event that satisfies a threshold deposit transaction amount; and
determining an event time of the historical deposit transaction event satisfies the threshold time period.

17. The system of claim 15, further comprising instructions that, when executed by the at least one processor, cause the system to generate the predicted classification label by:
generating a probability score of a future deposit transaction at the user account by utilizing the machine learning classification model with the one or more user account features of the user account; and
selecting the predicted classification label indicating the future deposit transaction activity or the future deposit transaction inactivity for the user account by comparing the probability score to a threshold probability score.

18. The system of claim 15, further comprising instructions that, when executed by the at least one processor, cause the system to modify, for the user account, a transmittal frequency of the electronic communication based on the predicted classification label indicating the future deposit transaction inactivity from the user account.

19. The system of claim 15, further comprising instructions that, when executed by the at least one processor, cause the system to:
generate, utilizing a machine learning classification model with one or more additional user account features corresponding to an additional user account, an additional predicted classification label for future deposit transaction activity of the additional user account;
determine, utilizing a fraud detection model with the one or more additional user account features, a fraudulent transaction activity for the additional user account; and
in response to the additional predicted classification label indicating an additional future deposit transaction inactivity from the additional user account and the fraudulent transaction activity for the additional user account, pause electronic communications, for the additional user account, comprising options to initiate deposit transaction activities within the inter-network facilitation system.

20. The system of claim 15, further comprising instructions that, when executed by the at least one processor, cause the system to:
generate, utilizing the machine learning classification model with one or more additional user account features corresponding to an additional user account, an additional predicted classification label for the future deposit transaction activity of the additional user account; and
in response to the additional predicted classification label indicating an additional future deposit transaction activity from the additional user account, pause electronic communications, for the additional user account, comprising options to initiate deposit transaction activities within the inter-network facilitation system.
